(19) United States
(12) Patent Application Publication
(10) Pub. No.: US 2007/0247573 A1
(43) Pub. Date: Oct. 25, 2007

(54) Transflective LC Display Having Narrow Band Backlight and Spectrally Notched Transflector

(75) Inventors: Andrew J. Ouderkirk, Woodbury, MN (US); Philip E. Watson, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/736,812

(22) Filed: Apr. 18, 2007

Related U.S. Application Data
(60) Provisional application No. 60/745,103, filed on Apr. 19, 2006.

(51) Int. Cl. G02F 1/1335

(52) U.S. Cl. 349/114

(57) ABSTRACT

A transflective display includes a front polarizer, a transflector, and a liquid crystal (LC) panel disposed between the front polarizer and the transflector. The display also includes a backlight for illuminating the LC panel in the transmissive viewing mode. The backlight emits light over selected relatively narrow portions of the visible spectrum, and the transflector has a spectrally variable reflectivity to selectively transmit the light emitted by the backlight and substantially reflect other visible wavelengths. This combination can increase the efficiency of the transflective display by enhancing the display brightness in both the reflective mode and the transmissive mode.

### CROSS REFERENCE TO RELATED APPLICATIONS

This application claims the benefit under 35 U.S.C. § 119(e) of U.S. Provisional Application 60/745,103, filed Apr. 19, 2006.

### FIELD OF THE INVENTION

The present invention relates to display devices, particularly those that utilize a liquid crystal (LC) panel and that can operate in both reflected ambient light and transmitted light originating from a backlight, and related articles and processes.

### DISCUSSION

Microprocessor-based devices that include electronic displays for conveying information to a viewer have become nearly ubiquitous. Mobile phones, handheld computers, personal digital assistants (PDAs), electronic games, MP3 players and other portable music players, car stereos and indicators, public displays, automated teller machines, in-store kiosks, home appliances, computer monitors, and televisions are examples of such devices. Many of the displays provided on such devices are liquid crystal displays (LCDs or LC displays).

Unlike cathode ray tube (CRT) displays, LCDs do not have a phosphorescent image screen that emits light and, thus, require a separate light source for viewing images formed on such displays. For example, a source of light can be located behind the display, which is generally known as a “backlight.” The backlight is situated on the opposite side of the LCD from the viewer, such that light generated by the backlight passes through the LCD to reach the viewer. An LC display using such a backlight can be said to be operating in “transmissive” mode. An alternative source of illumination can be from an external light source, such as ambient room lights or the sun.

Some LC displays are designed to operate in either of two modes: the transmissive mode utilizing a backlight, described above, or a “reflective” mode, utilizing light reflected from an external light source situated on the viewer-side of the LCD. Such LC displays, known as “transflective” displays, commonly possess an LC panel and a partially reflective layer between the LC panel and the backlight. In other cases, the partially reflective layer is disposed inside the LC panel rather than between the LC panel and the backlight. In either case, the partially reflective layer, referred to herein as a “transflector”, transmits a sufficient portion of light from the backlight, while also reflecting a sufficient portion of external light, to permit the display to be viewed in both transmissive mode and reflective mode. An exemplary transflector is Vikuiti™ Transflective Display Film (“TDF”) available from 3M Company. This film includes a reflective polarizer, i.e., a body that reflects light of one polarization state and transmits light of an orthogonal polarization state, formed from a polymeric multilayer optical film. The TDF product also includes a layer of diffuse adhesive.

The LC panel component of the LC display commonly includes two substrates and a liquid crystal material disposed between them. The substrates may be fabricated from glass, plastic, or other suitable transparent materials. The substrates are supplied with an array of electrodes that can provide electrical signals to a corresponding array of individual areas known as picture elements (pixels), which collectively define the viewing area of the display and individually define the resolution of the display. Electrical signals provided by the electrodes, typically in conjunction with thin film transistors (TFTs), permit the optics of each pixel to be adjusted, for example to either significantly modify the polarization state of transmitted light, or to allow the light to pass without significant modification to its polarization state. In some cases the electrical signal can switch the liquid crystal from a transmissive state to a scattering state, or provide some other optical change in the pixel. The LC panel typically does not include a highly absorptive color filter situated between the substrates. It may, however, include a weak color filter that absorbs less than 50% of incident light over the visible spectrum.

The liquid crystal material in the LC panel may be nematic, as in the case of a Twisted Nematic (TN), Optically Compensated Bend (OCB), Supertwisted Nematic (STN), or bistable nematic liquid crystal, or other known nematic modes. It may also be a smectic liquid crystal as used in Ferroelectric, Antiferroelectric, Ferrielectric, and other smectic modes. The liquid crystal may also be a cholesteric liquid crystal, a liquid crystal/polymer composite, a polymer-dispersed liquid crystal, or any other type of liquid crystal configuration that may be electrically switched between at least two optically differentiable states.

Usually, LC displays are either monochrome or color. In a monochrome display, each of the pixels in the viewing area can be made to be dark, bright, or an intermediate intensity level, as in a grayscale image. Such intensity modulation is usually used with white light to yield pixels that are white, black, or gray, but can alternatively be used with light of any other single color such as green, orange, etc. But such intensity modulation cannot produce a range of colors at any arbitrary location on the viewing area. In contrast, “full color” LC displays can produce a range of perceived colors, such as red, green, or blue, at any arbitrary location within the viewing area.

The design of traditional transflective systems often involves compromises between reflective brightness, transmissive brightness, and color generation. Typically, a transflective layer, located either between the transparent substrates of the liquid crystal panel, or between the liquid crystal panel and the backlight, will reflect a fraction of incident light in order to provide illumination from external sources in the reflective mode, and will transmit a different fraction of incident light in order to provide illumination from the backlight in the transmissive mode. The design of the transflector may be tuned such that the transmissive mode or reflective mode is brighter, often at the expense of the other.

### BRIEF SUMMARY

The present application discloses, inter alia, a transflective display having a reflective viewing mode and a transmissive viewing mode. The display includes a front polarizer, a transflector, and a liquid crystal (LC) panel disposed between the front polarizer and the transflector. The display also includes a backlight for illuminating the LC panel in the transmissive viewing mode. The backlight emits light over selected relatively narrow portions of the visible spectrum, and the transflector has a spectrally variable reflectivity to selectively transmit the light emitted by the backlight and substantially reflect other visible wavelengths. This combination can increase the efficiency of the transflective display by enhancing the display brightness in both the reflective mode and the transmissive mode.

In exemplary embodiments, the transflector's reflectivity changes with incidence angle, and the light emitted by the backlight is as least partially collimated, e.g., having a full angular width at half-maximum intensity (FWHM) of 40° or 20° or less in at least one dimension, and preferably in two orthogonal dimensions.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

FIG. 1 is a schematic side view of a portion of a transflective liquid crystal display having a narrow band emitting backlight and a transflector with a spectrally variable response tailored to substantially match the backlight emission;

FIG. 2 is a composite graph showing idealized representations of the light emitted by the backlight and the response of the transflector along its pass axis and its block axis, as a function of wavelength;

FIG. 3 is a graph showing idealized representations of the response of a modified transflector along a first and second block axis as a function of wavelength;

FIG. 4 is a schematic side view of a portion of another transflective liquid crystal display having a narrow band emitting backlight and a spectrally variable transflector;

FIG. 5 is a composite graph of intensity versus time for the various light components emitted by the backlight; and

FIG. 6 is a schematic plan view of a portion of a patterned filter.

In the figures, like reference numerals designate like elements.

### DETAILED DESCRIPTION OF ILLUSTRATIVE EMBODIMENTS

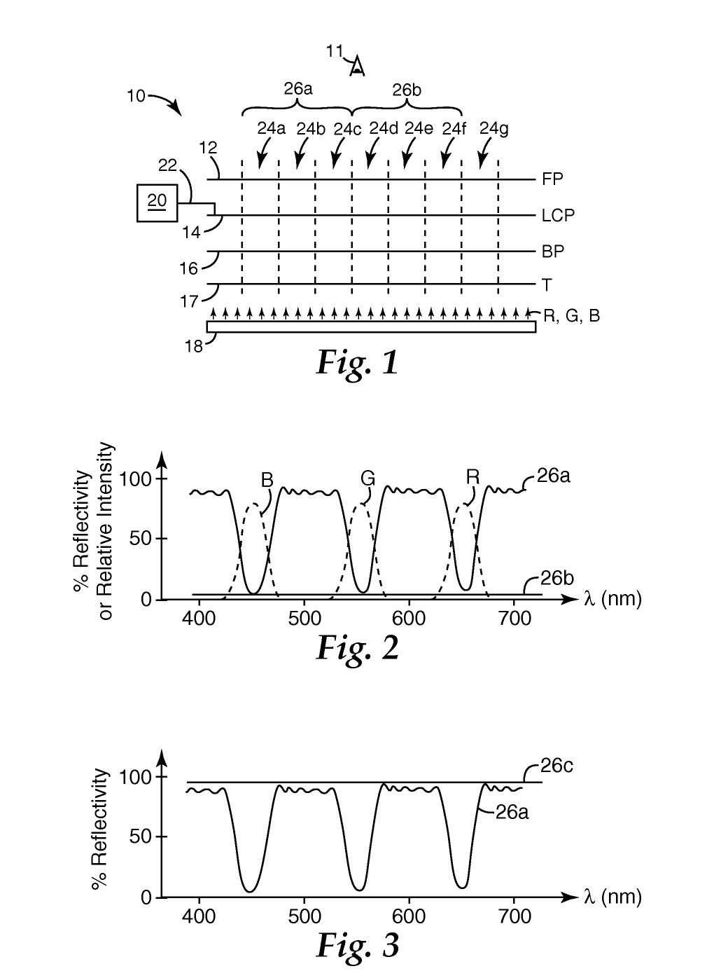

FIG. 1 shows a schematic side view of a portion of a transflective LC display 10 that includes a front polarizer 12, an LC panel 14, a back polarizer 16, a transflector 17, and a backlight 18. A controller 20 is electronically coupled to LC panel 14 via a connection 22 to control the optical state of individual pixels 24a-g of the LC panel, which pixels extend in a repeating pattern or array over an area that defines the overall viewing area of the display.

Front polarizer 12 can be any known polarizer, but in exemplary embodiments it is an absorptive polarizer (sometimes also referred to as a dichroic polarizer) for ease of viewing and reduced glare for observer 11. Preferably, polarizer 12 is a flexible polymer-based film and is laminated or otherwise adhered to LC panel 14, for example, using an optically clear adhesive. If polarizer 12 is a linear polarizer, it has a pass axis and a block axis in the plane of the film or layer. Light polarized parallel to the pass axis is transmitted, and light polarized parallel to the block axis (perpendicular to the pass axis) is blocked e.g. by absorption, by the front polarizer 12.

LC panel 14 includes a liquid crystal material sealed between two transparent substrates and an array of electrodes that define a corresponding array of pixels 24a-g. A controller 20 is capable of addressing or controlling each of the pixels individually so as to form a desired image. Depending on whether a given pixel is turned on or off, or at an intermediate state, the LC panel rotates the polarization of light passing therethrough by about 90 degrees, or by about zero degrees, or by an intermediate amount. The LC panel may have its front face attached to the front polarizer, and may also include a diffuser film, an antireflection film, an anti-glare surface, or other front-surface treatments.

Back polarizer 16 is an absorptive polarizer. It has a pass axis and a block axis similar to front polarizer 12. Most typically, the pass axis of back polarizer 16 is oriented to be substantially perpendicular to the pass axis of front polarizer 12, but other orientations are also possible. Back polarizer 16 provides insufficient reflection of incident light to support the reflective viewing mode of the display 10.

Since back polarizer 16 is absorptive, display 10 is a non-inverting type transflector, because pixels 24 whose state (determined by controller 20) makes them bright in reflective viewing mode also makes them bright in transmissive viewing mode, and pixels 24 whose state makes them dark in reflective viewing mode also makes them dark in transmissive viewing mode. In this regard, transflective displays generally fall under two classes of operation: inverting and non-inverting. Non-inverting displays provide the same image in both the reflective and transmissive operating modes, because in both cases, any light that exits the display travels from the transflector to the back polarizer (which defines the light's polarization state), through the LC panel, and exits through the front polarizer. External light incident on the display passes through the front polarizer, through the LC panel, through the back polarizer, reflects from the transflector, passes back through the back polarizer and the LC panel, and exits through the front polarizer. Light from the backlight passes through the transflector, through the back polarizer, through the LC panel, and exits through the front polarizer. Since the two operating modes provide similar images, the light exiting the system from the reflective and transmissive modes will work together to provide a brighter overall image. Typically, in cases where the transflector does not also act as the display back polarizer, the display is non-inverting. But some non-inverting displays can include a reflective polarizer as the transflector.

Inverting displays commonly utilize a reflective polarizer for the transflector, and that reflective polarizer is also the back polarizer of the LC display. The transflector may, for example, be a sheet of Vikuiti™ RDF-C film (3M Company, St. Paul, Minn.) laminated in place of a conventional absorptive back polarizer in the display. The RDF-C film includes a polymeric multilayer reflective polarizer and a layer of light-diffusing adhesive. Using such a film, external light incident on the display can pass through the front polarizer, then through the LC panel, and impinge on the transflector. At this point, one polarization state (state “1”) is reflected, and passes back through the LC panel and the front polarizer. But light of an orthogonal polarization state (state “2”) is transmitted by the transflector and is absorbed or otherwise lost in the vicinity of the backlight. For light originating from the backlight, polarization state 2 is transmitted through the transflector, through the LC panel, and through the front polarizer, while polarization state 1 is reflected back into the backlight and lost. Thus, the reflective operating mode introduces polarization state 1 into the LC panel, while the transmissive operating mode introduces polarization state 2 into the LC panel, and the two images will therefore be reversed. Consequently, in such a display, the transmissive mode image appears as a photo-negative of the reflective mode image.

In the case of inverting displays, it is also possible to modify the image output electronically using the LC panel controller in order to correct for the optical inversion. The controller may for example include an electronic inversion algorithm that is activated or not depending upon whether the backlight is energized, i.e., depending on whether the display is in reflective mode or transmissive mode. Such an algorithm can electronically modify the control signals to the individual pixels to electronically invert the image in the transmissive mode when the backlight is activated, so that the image appears with the same foreground/background scheme as in the reflective mode.

Turning our attention again to FIG. 1, display 10 also includes a transflector 17 because the back polarizer has insufficient reflectivity for the reflective viewing mode. The transflector is partially reflective so that some of the light originating from outside the display and passing through elements 12, 14, and 16 is reflected back through those elements to enable observer 11 to easily see the image in the reflective mode. But the transflector is also partially transmissive so that light originating from the backlight is not trapped in the backlight, but able to exit the display through elements 12, 14, and 16 so the observer can also see the image in the transmissive viewing mode. If the transflector is only a simple partial reflector, such as a thin layer of aluminum forming a half-silvered mirror, then modifying the transflector to have greater reflectivity improves the reflective viewing mode while degrading the transmissive viewing mode, and modifying the transflector to have greater transmission improves the transmissive mode while degrading the reflective mode.

Transflector 17 can alternatively be or include a reflective polarizer, such as one of polymeric multilayer design as described in U.S. Pat. No. 5,882,774 (Jonza et al.), or U.S. Application Publication Nos. 2002/0190406 (Merrill et al.), 2002/0180107 (Jackson et al.), 2004/0099992 (Merrill et al.) or 2004/0099993 (Jackson et al.). Such a polarizer typically has negligible absorption over visible wavelengths, and has a pass axis and a block axis in the plane of the polarizer, where visible light polarized parallel to the pass axis is substantially transmitted and visible light polarized parallel to the block axis is substantially reflected. In order for such a polarizer to function as a transflector in the display 10, the pass axis is preferably oriented at an oblique angle relative to both the pass axis and the block axis of the back polarizer 16. Otherwise, the reflective polarizer either reflects little or no light in the reflective viewing mode (in the event the pass axis of the reflective polarizer is aligned with the pass axis of back polarizer 16) or transmits little or no light in the transmissive viewing mode (in the event the pass axis of the reflective polarizer is orthogonal to the pass axis of back polarizer 16). Adjusting the orientation of the reflective polarizer relative to the back polarizer 16 can enhance either the reflective mode or the transmissive mode but not both, and again an enhancement of one mode causes a degradation of the other mode.

Advantageously, the tradeoff between increasing the reflectivity or increasing the transmissivity of the transflector can be avoided to a significant extent if the spectral content of the external light and that of the backlight are sufficiently different from each other, and/or if the angular distribution of emitted light from the external source is sufficiently different from that of the backlight, and if the transflector has a spectral response that is tailored to accommodate those differences. The external light is often from a broadband source such as the sun, and it is usually difficult to specify or control the spectral content thereof. The angular distribution is also often difficult to control, particularly on cloudy days or in office environments or other internal environments in which light impinges on the display from all directions. The spectral content and angular distribution of the backlight 18, on the other hand, are usually much easier to specify or control. For example, by utilizing narrow band visible light sources such as LEDs, the backlight 18 can be made to emit narrow band light preferably in a narrow angular emission cone to distinguish it from the broadband external illumination. The narrow emission cone preferably has a full angular width at half-maximum intensity (FWHM) of 40° or 20° or less in at least one dimension, and preferably in two orthogonal dimensions. Then, the transflector 17 can be designed so that, rather than simply reflecting about 50% and transmitting about 50% of all visible wavelengths, it can have a much higher transmission (lower reflectivity) in the narrow wavelength band(s) of the backlight emission, and much higher reflectivity (lower transmission) at other visible wavelengths, for more efficient separation of the light.

In one embodiment, backlight 18 can include only a source or sources emitting in a single wavelength band, e.g. a red emission band using one or more red LEDs, or a green emission band using green-emitting LED(s), or a blue emission band using blue-emitting LED(s), or any other suitable color. Preferably, the spectral width (measured as the full width at half maximum, or FWHM) of a given emission band is narrow in comparison to the visible light spectrum, preferably 50, 35, or 20 nm or less. Light sources other than LEDs can also be used, including broader band sources combined with filters to render them narrow band emitters. For example, fluorescent lamps including cold cathode fluorescent lamps (CCFLs) can be used. Filtered sources, however, generally have poorer electrical-to-optical efficiency than inherently narrow band emitters. Therefore, it is desirable to use inherently narrow band sources, such as LEDs (including conventional light emitting diodes and superluminescent emitting diodes) and similar devices such as laser diodes, in the backlight 18.

In other embodiments, backlight 18 includes multiple sources emitting in different narrow bands of the visible spectrum, where the number of different light sources or bands is small enough, and/or the spectral width of the bands is small enough, so that the resulting group of bands still covers only a fraction of the entire visible spectrum.

FIG. 2 is a composite graph showing idealized representations of light emitted by the backlight and the response of the transflector along its pass axis and its block axis, as a function of wavelength. Curves R, G, and B in FIG. 2 represent relative spectral intensities of red, green, and blue LEDs respectively. Curve 26a represents a possible spectral reflectivity for light polarized along a block axis of transflector 17, and curve 26b represents a possible spectral reflectivity for light polarized along a pass axis of transflector 17. Absorption or other losses in the transflector 17 detract from efficiency, and are preferably low enough so that the transmissivity and reflectivity are substantially complementary, i.e., % transmissivity+% reflectivity≈100%. With such reflectivity characteristics, transflector 17 is a spectrally selective reflective polarizer, which can be readily fabricated using known technologies, such as cholesteric films with quarter-wave retarders, or inorganic multilayer film stacks evaporated onto a substrate, or coextruded polymer constructions discussed in U.S. Pat. Nos. 5,882,774 (Jonza et al.), 6,157,490 (Wheatley et al.), and 6,531,230 (Weber et al.). These technologies generally rely on constructive or destructive interference of light to produce the spectrally selective reflection and transmission properties. Consequently, transflectors that utilize these technologies usually experience a shift in the spectral properties with incidence angle. Curve 26a, therefore, may represent the percent reflectivity of normally incident light, or of light incident at a slightly different angle of incidence, or it may represent the average percent reflectivity over a relatively narrow cone of incidence angles, e.g., centered at normal incidence. In any case, as the incidence angle of the light increases, the spectral features of curve 26a generally shift to shorter wavelengths.

The amount of shift in the spectral properties of thin film stacks as a function of angle can be influenced by the magnitude of the refractive index mismatch between adjacent microlayers in the stack. By making the refractive index mismatch large, e.g. by appropriate selection of polymeric materials and processing conditions of the thin film stack, the spectral shift with angle can be reduced.

Referring to both FIG. 1 and FIG. 2, backlight 18 contains narrow band light sources that emit in a red, green, and blue band of the visible spectrum. When emitted simultaneously, the backlight has a white appearance. For purposes of the present discussion the emitted narrow band light is assumed to be unpolarized. The portion of the emitted light polarized along the pass axis of transflector 17 is substantially transmitted thereby, and advances to the back polarizer 16. At the back polarizer, such light is substantially all absorbed, because the pass axis of transflector 17 is preferably substantially aligned with the block axis of the back polarizer.

The portion of light emitted by the backlight 18 and polarized along the “block axis” of transflector 17 will in fact not be substantially blocked, as a result of dips or notches in the otherwise high reflectivity curve 26a. These dips or notches—technically, gaps between reflection bands—have a low reflectivity and high transmissivity, and are tailored to be nominally aligned or matched with the peak output wavelengths of the narrow band sources. The RGB light of this polarization state then advances to the back polarizer 16, where it is all substantially transmitted, since the block axis of transflector 17 is preferably aligned with the pass axis of back polarizer 16. Thereafter, this light either experiences a rotation of its polarization state or not at the LC panel 14, depending on the state of the individual pixels 24a, 24b, etc., and consequently is either transmitted or absorbed by front polarizer 12 on a pixel-by-pixel basis to form a monochrome image.

With regard to the reflective viewing mode, the transflector's relatively wide spectral regions of high reflectivity (curve 26a) help ensure a bright image for the observer. We assume the external light source is the sun, an incandescent bulb, or another wide-band source that emits over substantially the entire visible spectrum, or other sources that emit predominately at wavelengths other than those emitted by backlight 18 and/or in angular directions that differ from those of the backlight, so that such light is highly reflected by the transflector. Also assuming this external light is unpolarized, half of the light is absorbed at the front polarizer 12 and the other half (the portion polarized along the pass axis of the front polarizer) is transmitted. The polarization state is then rotated or not at the LC panel 14, depending on the state of the individual pixels 24a, 24b, etc. For pixels that are turned off, the polarization state of the light is aligned with the block axis of back polarizer 16, and is absorbed. For pixels that are turned on, the polarization state of the light is aligned with the pass axis of the back polarizer 16, and the light advances to transflector 17. Here, the light is polarized parallel to the transflector's block axis, and a substantial portion, preferably greater than 50% or 60%, of the incident light is reflected by virtue of the high average reflectivity of curve 26a over the wavelength range and angular range of the external source. Light whose wavelength is in a region of low reflectivity of curve 26a is transmitted, and then absorbed or otherwise lost in the vicinity of the backlight. The reflected light, however, travels back through elements 16, 14, and 12, producing the bright pixels in the image. Note that—as a result of the complementary nature of the transmission and reflection characteristics of the transflector—this light will have a spectral content that is substantially complementary to that of the backlight. Thus, wavelengths of peak intensity in the transmissive viewing mode of the display 10 will differ from wavelengths of peak intensity in the reflective viewing mode.

Note also that it is possible for the external light source to have an emission spectrum similar to or even identical to that of a narrow band backlight, provided the light incident on the transflector from the external source has a sufficiently different angular distribution than light from the backlight, and provided the spectral properties of the transflector shift with the incident light direction. For example, the spectral notch or notches in the otherwise high reflectivity of the block axis of the transflector may be relatively narrow and carefully tuned to both the specific wavelength(s) and the specific incidence direction (e.g. normal incidence) for substantially collimated narrow band light emitted by the backlight. If the external source is also narrow band and emits at the same specific wavelength(s), the transflector can still reflect such light to the extent it is incident at a substantially different angle, at which the spectral notch or notches have spectrally shifted to substantially avoid such specific wavelengths.

If it is not important that the transmissive viewing mode operates with white light, then only two or only one of the RGB sources can be used in the backlight, so that only two or only one corresponding dip or notch is provided in the reflectivity curve (see curve 26a), thus permitting the transflector to have an even higher average reflectivity over visible wavelengths and a higher average transmissivity (lower reflectivity) for the narrow wavelength band(s), for the block polarization state.

Although shown only schematically, backlight 18 also typically includes conventional components such as light guides, light enhancement films, lenses, and other components to provide preferably substantially uniform and efficient illumination over the viewing area of the display. Preferably, backlight 18 also includes a collimating film or device so that the emitted light is at least partially collimated, or distributed over a range of angles substantially narrower than a Lambertian emitter. A wedge-shaped light guide in combination with a prismatic turning film are useful for producing such an angular distribution. Another useful combination is a direct lit backlight having a diffusing cavity and two substantially crossed (orthogonally oriented) sheets of prismatic brightness enhancing films such as any of the Vikuiti™ BEF line of products. Improving the collimation of the backlight-emitted light helps to ensure that the spectral notches in the reflectivity curve remain aligned with the wavelengths emitted by the backlight, since the reflection and transmission bands of an interference reflector generally shift to shorter wavelengths with increasing angle of incidence.

Some additional efficiency can be realized in the display 10 if the backlight 18 also includes a polarization-scrambling element, such as a roughened back reflector, and if the low reflectivity pass axis of the transflector described above (see curve 26b) is replaced with a high reflectivity characteristic. This is shown in the graph of FIG. 3, plotting percent reflectivity versus wavelength for a modified transflector. The modified transflector still has the spectrally variable reflectivity (curve 26a) along a block axis that is aligned with the pass axis of the back polarizer 16, and the notches or dips in that reflectivity curve still correspond to narrow band RGB light sources in the backlight. However, along an orthogonal in-plane axis (referred to here as a second block axis, to distinguish it from the first-mentioned block axis), all visible light—or at least the light emitted by the backlight—is substantially reflected, instead of being substantially transmitted. This change in reflectivity has little or no effect on the reflective viewing mode, provided the transflector is oriented so that the first block axis is aligned with the pass axis of back polarizer 16, since the second block axis is then orthogonal to such pass axis. But the difference can help brighten the transmissive viewing mode, since the half of the unpolarized light emitted by the backlight that was absorbed by the back polarizer is now reflected back into the backlight. The polarization scrambling element in the backlight converts some of this light to the polarization state that will pass through the back polarizer, thus providing a light recycling mechanism for improved efficiency and performance. Note that the combined characteristics 26a, 26c can be achieved, for example, by laminating the transflector described previously to a conventional broadband linear reflective polarizer, whose block axis is oriented parallel to the pass axis of the original transflector, to produce the modified transflector.

Note that although curve 26a shows notches or dips in reflectivity that reach local minimum values approaching 0%, those local minimum values can be tailored—with appropriate materials and processing conditions to achieve the necessary refractive index and thickness profile relationships—to higher values, such as up to 10%, or up to 30% or even 50% reflectivity, as long as those higher values are still substantially less than the baseline reflectivity between the notches or dips. Increasing the value of the local minimum reflectivity can enhance the display brightness in reflective mode, and may enhance the backlight uniformity in transmissive mode.

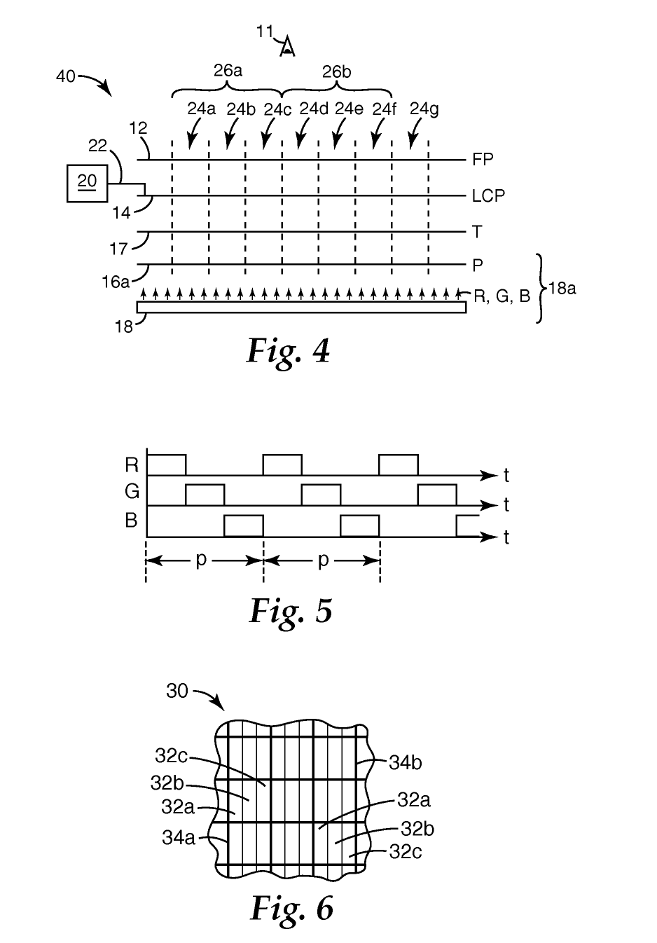

FIG. 4 shows a portion of a transflective display 40 similar to display 10, but where the transflector 17, which is or comprises a reflective polarizer, has been moved to be immediately behind the LC panel 14, thus serving as the back polarizer for the display. Transflector 17 may also include a light diffusing layer or means, such as the polarization preserving diffusing adhesive layer in the Vikuiti™ RDF-C and TDF film products. As described above, transflector 17 can have the reflectivity characteristics 26a, 26b shown in FIG. 2, or, if backlight 18 emits in only one or two narrow bands, the reflectivity 26a along the block axis can have only one or two notches or dips matched to such bands. Of course, other numbers of bands and corresponding spectral notches are also contemplated, and a three-color backlight is not limited to the red, green, and blue spectral regions. The block axis of the transflector can be parallel or orthogonal to the pass axis of front polarizer 12, but for most types of LC displays it is preferably orthogonal thereto.

An absorptive polarizer 16a, similar to back polarizer 16, is included between the transflector 17 and the backlight 18. Preferably the pass axis of such polarizer is aligned with the block axis of transflector 17. The block axis of the polarizer is then aligned with the pass axis of the transflector.

With this setup, display 40 is a non-inverting type of transflective display. In reflective mode, external broadband light is polarized by front polarizer 12, passes through the pixels of the LC panel 14, and reaches the transflector 17. There, light for some pixels has a first polarization state (aligned with the pass axis of the transflector), passes through to the absorptive polarizer 16a, and is absorbed there. Light for other pixels has an orthogonal second polarization state and is selectively spectrally reflected at the transflector, with most of the light preferably being reflected back through the LC panel 14 and front polarizer 12. The remainder of the light of this second polarization state, having wavelengths within the spectral notches of the transflector, passes through the block axis of transflector 17, through the pass axis of polarizer 16a, and is absorbed or otherwise lost in the vicinity of backlight 18. Note again that to the extent the spectral notches of the transflector shift with incidence angle, a significant portion of light from the external source is incident both at suitable wavelengths and at suitable incidence directions that substantially avoid the low reflectivity notches. If, for example, the external source is both broadband and non-collimated, some relatively narrow bands of the light will pass through the transflector at a given incidence angle, but when averaged over the visible wavelengths and over the range of incidence angles most of the light is reflected.

In transmissive mode, the emitted narrow band light is polarized by polarizer 16a, half being absorbed and half advancing to transflector 17. Due to the alignment of the pass axis of polarizer 16a with the block axis of transflector 17, and the spectral notch(es) provided in the block axis reflectivity spectrum of the transflector, the now polarized narrow band light substantially passes through the transflector and then through the LC panel 14, reaching the front polarizer 12. There, depending on the orientation of the transflector relative to the front polarizer and the state of the individual pixels 24, light for some pixels is polarized parallel to the pass axis of the front polarizer, and be transmitted to the viewer 11. Light for other pixels is polarized parallel to the block axis of the front polarizer, and is absorbed. The same pixels that are bright in this transmissive mode are also bright in reflective mode, and likewise with dark pixels.

Polarizer 16a and backlight 18 can be combined to form a polarized backlight 18a. Alternatively, the backlight 18 can incorporate one or more polarized narrow band light sources to provide the same type of light output. For example, polarized light sources such as the polarized phosphor-based LEDs disclosed in WO 2004/068602 (Ouderkirk et al.), or the polarized LEDs disclosed in U.S. Patent Publication No. US 2006/0091412 (Wheatley et al.), or a CCFL fluorescent lamp covered or wrapped with a reflective polarizer such as Vikuiti™ DBEF film, can be used to inject polarized light into an end of a wedge-shaped light guide. The light guide and its light extraction features can be made to be substantially polarization preserving, and produce a relatively collimated and polarized illumination of the viewing area of the display.

In another alternative construction to that of FIG. 4, a reflective polarizer can be placed between absorbing polarizer 16a and backlight 18, and the backlight can include a polarization-scrambling element such as a roughened back reflector. By orienting the block axis of the reflective polarizer to be substantially parallel to the block axis of absorbing polarizer 16a, some additional efficiency can be realized in the display by recycling light from the backlight 18 that would otherwise be absorbed at polarizer 16a. The polarization scrambling element in the backlight converts some of this light to the polarization state that will pass through the absorptive polarizer 16a, as discussed above.

The above descriptions describe transflective systems that are substantially monochrome in both the reflective and transmissive viewing modes. If desired, those systems can all be modified to provide full color operation, in which a range of perceived colors, such as red, green, or blue, can be produced at any arbitrary location within the viewing area. One approach for this is to provide a conventional color filter in the LC panel or elsewhere in the light path of both the reflective viewing mode and the transmissive viewing mode, yielding full color operation in both modes. Such color filter typically comprises a grid or array of printed pigments in spatial registration with the LC pixels, so that each pixel is permanently assigned to a given color pigment. Most commonly, red, green, and blue pigments are used, but other arrangements are also contemplated. One disadvantage of the conventional color filter is its substantial average absorption, leading to a dimmer or darker image, particularly in reflective mode.

One approach that avoids this problem generates the constituent colors between the transflector and the backlight, including in the backlight itself. This produces a system that is still monochrome in reflective mode, but full color in transmissive mode.

One version of this approach separates the constituent colors temporally. Here, the backlight is modulated to emit the constituent colors in a predetermined sequence, e.g., red, green, and blue as shown in FIG. 5. The constituent colors, which in this case are limited to narrow bands as described above, are flashed on and off in a repeating sequence whose period p is short enough so that a human observer will perceive all the colors together, e.g., white light. Preferably, the period corresponds to a frequency of 40 Hz, 75 Hz, or more. In the transmitted viewing mode, the pixels of the LC panel 14 are controlled in a synchronous fashion with the backlight, so that at one moment all of the pixels display the red-filtered version of the image and the backlight emits red light, at another moment all of the pixels display the green-filtered version of the image and the backlight emits green light, and at still another moment all of the pixels display the blue-filtered version of the image and the backlight emits blue light, resulting in a perceived full color image for fast cycle rates. In the reflective viewing mode, the controller 20 addresses the pixels in a conventional monochrome fashion. For a given physical pixel size on the LC panel, the same spatial resolution is available for both the reflective (monochrome) mode and the transmissive (full color) mode.

Another version of this approach separates the constituent colors spatially. Here, the backlight projects or casts multicolored pixilated light (e.g. distinct red, green, and blue spots of light arranged in a regular repeating array) in registration with the pixels of the LC panel so that some pixels, if they are turned on, transmit light of a first color, other pixels transmit light of a second color, and the remaining pixels transmit light of a third color. A variety of backlight constructions are capable of producing the spatially separated light components. We will describe briefly several techniques, without wishing to be limited thereby: separation by diffraction (diffractive color separation, DCS), separation by dispersion (refractive color separation, RCS), and separation by a patterned absorptive or reflective filter (backlight color filtering, BCF). These backlight-based color separation techniques can allow the LC display to operate in a low-power monochrome or weakly colored reflective mode having little or no absorptive losses, but also provide full-color images in the transmissive mode as needed. This is because there is preferably substantially no pixilated color filter (but there may be a weak pixilated color filter) within the LC panel or anywhere in the light path on the viewer side of the transflector. With the spatial separation of the constituent colors, a lower spatial resolution is possible in transmissive (full color) mode compared to the reflective (monochrome) mode, because multiple adjacent pixels are needed for the different constituent colors to provide an overall or combination pixel (which is larger than an individual pixel) in the transmissive mode.

With the spatial separation technique, the backlight includes components to illuminate the entire viewing area of the display but in a spectrally and spatially divided fashion to form an array of spectrally distinguishable narrow band light components over that viewing area, the array being in registration with the pixels of the LC panel. An exemplary array is a rectangular grid of alternating red, green, and blue light components, but other repeating patterns are also contemplated, such as RGBG, and so forth. The spatial separation can be achieved straightforwardly with a patterned absorptive or reflective (e.g. multilayer or other interference) filter, referred to above as the BCF technique. Spatial separation can also utilize components that angularly separate different wavelengths of light, as with the DCS and RCS techniques. These latter DCS and RCS techniques may require a relatively high degree of collimation of light at the input of the diffractive or dispersive component, so that the angular separation can adequately isolate the different light components spatially.

In the DCS technique, the backlight preferably includes a collimating system, a grating system, and a lens system. The collimating system, typically a wedge-shaped light guide coupled with a prismatic turning film, or of any type of backlight with prismatic Brightness Enhancement Film such as 3M's BEF, takes input light and projects it toward the grating system with a narrow light cone, of FWHM of 40° or less in at least one dimension, and preferably of FWHM of 20° or less. The grating system, commonly in the form of an optical blazed phase grating, separates the light angularly into color bands. The lens system, typically a 1-dimensional (single row of long, narrow elements) or 2-dimensional (rows and columns of elements) microlens array, takes light from the grating system, and focuses it onto an image plane in the form of color-separated lines, dots, or other defined regions, thus producing spatially separated multiple light components. In some cases, the lens system may be replaced by a diffusion system located at a controlled distance from the grating system so as to forward-scatter incident light, providing a multi-colored light plane for illuminating the display.

The lens system and grating system can be combined into a single element, where the grating and lens are on the same side or opposite sides of a monolithic or few-layer film. Alternatively, they may be formed as separate elements, or be combined with other elements in the display system. For example, the grating may be disposed on one face of a wedge-shaped light guide, while a lens film may be combined into a single film with the transflector, such as through lamination or direct microreplication using a metal tool and a photocurable polymer onto the transflector surface, or they may be combined by other means.

Representative DCS-related backlights, light sources, or components thereof suitable for use in the backlight of a disclosed transflective include those described in U.S. Pat. Nos. 5,497,269 (Gal), 5,600,486 (Gal et al.), 5,889,567 (Swanson et al.), 6,618,106 (Gunn et al.), and U.S. Patent Publications US 2005/0041174 (Numata et al.) and US 2005/0078374 (Taira et al.).

A backlight employing an RCS-related technique separates light by the same optical principle at work when projecting a rainbow from a sunlit equilateral triangular parallelepiped glass prism. That is, the refractive index of the material changes monotonically over the wavelength range of interest, and the angle of refraction of obliquely incident light therefore also changes as a function of the wavelength or color of the light. The RCS-based backlight typically includes a prism system and a lens system. Each of these systems may be or include a microreplicated or otherwise molded sheet or film. For maximum color separation, at least the prism system is preferably composed of a material having a large monotonic dispersion over the visible spectrum, e.g., a liquid crystal polymer. Reference is also made to U.S. Pat. No. 4,686,519 (Yoshida et al.) for RCS-related components suitable for use in backlight.

The backlight may also employ the BCF technique, in which an otherwise conventional white extended backlight illuminates a patterned filter. The filter has areas or cells corresponding to the LC panel pixels, and selectively transmit a designated one of the multiple light components. FIG. 6 depicts schematically representative filter areas or cells of such a patterned filter. In FIG. 6, pattern 30 has rectangular areas or cells 32a, 32b, 32c that repeat along columns and rows of a rectangular array sized to mate with a corresponding rectangular array of LC panel pixels. Cells 32a,b,c may transmit red, green, and blue light respectively, or other sets of usually three or more distinguishable colors capable of producing white light as desired.

Note that groups of neighboring cells form larger cells 34a, 34b, which substantially represent the resolution of the display when it is operating in the full-color transmissive viewing mode. Interestingly, finer resolution is achievable in monochrome reflective viewing mode, because pixels of the LC panel corresponding to the smaller cells 32a can then be used as the smallest addressable element of the image. This difference in resolution is also depicted in FIGS. 1 and 4, where pixels 24a-c can function as different colored sub-pixels of a larger pixel 26a, and pixels 24d-f can function as different colored sub-pixels of a larger pixel 26b, and so forth.

An actual difference in resolution from one viewing mode to the other can only be achieved if the controller 20 activating the pixels 24 is programmed accordingly. Thus, in reflective viewing mode with backlight 18 turned off, controller 20 processes the image in high resolution monochrome, driving each individual pixel 24 independently to form the high resolution image. In transmissive viewing mode, with backlight 18 turned on, controller 20 processes the image in a lower resolution color format, where the larger combination pixels 26a, 26b, etc. define the smallest spatial resolution and their constituent sub-pixels (24a,b,c for example) are driven with a predetermined relationship in order to produce the correct resultant color for the larger pixel (26a, for example). Preferably, the controller 20 switches automatically between the high resolution monochrome control mode and the lower resolution color control mode according to the status of the backlight. Thus, if the user activates a switch, or if a sensor is included to detect the ambient light level, and the light level falls below a predetermined value, then a backlight controller (not shown) energizes the backlight 18 to turn the backlight on or to keep it on, and controller 20 detects this status of the backlight. In response, LC panel controller 20 processes the image using the low resolution color control mode, and drives the pixels of the LC panel 14 via connection 22 accordingly. If the user then activates another switch or the ambient light level rises above another predetermined value, the backlight controller can shut the backlight 18 off, and in response to the status change the controller 20 can then process the image using the higher resolution monochrome control mode and drive the LC panel pixels accordingly.

In cases where the backlight 18 uses multiple distinct lamps or light sources to provide the multiple light components required for full color operation, it may be advantageous for power savings or for other reasons to allow the backlight controller to energize less than all or even only one of such lamps or light sources, even if full color operation is then sacrificed.

Returning again to FIG. 6, filter pattern 30 can be implemented in a variety of films, coatings, or substrates. For example, conventional colored pigments that selectively transmit narrow bands of red, green, and blue light, but absorb other wavelengths, can be printed on a transparent film or substrate.

Alternatively, an interference film such as a multilayer optical film having high reflectivity over the visible spectrum except in a narrow wavelength band can be used. Such films are described in the '774 Jonza et al. patent referenced above, and in U.S. Pat. No. 6,157,490 (Wheatley et al.). Preferably, such a film is initially made (e.g. by coextrusion of tens, hundreds, or thousands of extremely thin alternating polymer layers and subsequent stretching of the film in one or two orthogonal directions) with a narrow transmission band at the longest visible wavelength desired, such as a red wavelength band corresponding to that desired for cells 32a. This multilayer film, which is initially substantially uniform over its entire area, is then embossed in a series of rectangular areas corresponding to cells 32b. The embossing is adjusted to thin the layers of the multilayer film in the cells 32b to shift the transmission band from the initial long wavelength to a shorter wavelength, such as from red wavelengths (e.g. about 650 nm) to green wavelengths (e.g. about 550 nm). Thereafter, another embossing step is carried out on cells 32c, where the embossing is adjusted to thin the layers at those locations to shift the transmission band to even shorter wavelengths, such as from red wavelengths (e.g. about 650 nm) to blue wavelengths (e.g. about 450 nm). In alternative approaches, the embossing steps can be performed simultaneously with a suitably shaped embossing tool or drum. Also, the initial long wavelength transmission band may be positioned at a slightly longer wavelength than the longest wavelength band desired for the filter. For example, the initial long wavelength transmission band may be positioned in the near infrared region. Then, all areas or cells making up the filter pattern may be selectively embossed to a degree sufficient to move the transmission band to the desired filter band for each of the respective areas or cells of the pattern. The embossing of the different areas can be done in separate embossing steps or a single step. In any event, the result of such an embossing procedure is an interference filter that transmits light of selected wavelengths in the respective areas or cells making up the pattern, and reflects other light. Such a filter can, similarly to the patterned absorptive filter, be laminated to other components or otherwise included in the backlight 18 to provide the spatially separated multiple light components.

Unless otherwise indicated, all numbers expressing quantities, measurement of properties and so forth used in the specification and claims are to be understood as being modified in all instances by the term “about.” Accordingly, unless indicated to the contrary, the numerical parameters set forth in the specification and claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The foregoing description is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention. All patents and patent applications referred to herein are incorporated by reference in their entireties, except to the extent they are contradictory to the foregoing specification.

1. A transflective display having a reflective viewing mode and a transmissive viewing mode, the display comprising:
a front polarizer;
a transflector;
a liquid crystal (LC) panel disposed between the front polarizer and the transflector; and
a backlight for illuminating the LC panel in the transmissive viewing mode;
wherein the backlight emits light over selected portions of the visible spectrum; and
wherein the transflector has a spectrally variable reflectivity to selectively transmit the light emitted by the backlight.

2. The display of claim 1, wherein the backlight includes a plurality of narrow band light sources.

3. The display of claim 2, wherein the plurality of narrow band light sources includes a first LED emitting substantially blue light, a second LED emitting substantially green light, and a third LED emitting substantially red light.

4. The display of claim 1, wherein the front polarizer is an absorptive polarizer.

5. The display of claim 1, wherein the transflector includes a reflective polarizer.

6. The display of claim 1, wherein the transflector has a first block axis and a first pass axis orthogonal to each other in a plane of the transflector, and the spectrally variable reflectivity is a reflectivity for light polarized along the first block axis of the reflective polarizer, such reflectivity being lower for wavelengths of light emitted by the backlight than for other visible wavelengths.

7. The display of claim 6, wherein the transflector substantially transmits visible light polarized along the first pass axis.

8. The display of claim 1, wherein the transflector has a first block axis and a second block axis orthogonal to each other in a plane of the transflector, and the spectrally variable reflectivity is a reflectivity for light polarized along the first block axis of the reflective polarizer, such reflectivity being lower for wavelengths of light emitted by the backlight than for other visible wavelengths.

9. The display of claim 8, wherein the transflector substantially reflects visible light polarized along the second block axis.

10. The display of claim 9, wherein the backlight includes a polarization scrambling layer to convert at least some light polarized along the second block axis to light polarized along the first block axis.

11. The display of claim 1, further comprising:
a back polarizer disposed between the LC panel and the transflector.

12. The display of claim 11, wherein the back polarizer is an absorptive polarizer.

13. The display of claim 1, further comprising:
an absorptive polarizer between the transflector and the backlight.

14. The display of claim 1, wherein the backlight emits polarized light.

15. The display of claim 1, wherein the selected portions of the visible spectrum comprise one or more distinct bands whose full width at half maximum (FWHM) is no greater than 50, 35, or 20 nm.

16. The display of claim 1, wherein the spectrally variable reflectivity includes a high reflectivity with one or more low reflectivity notches therein for at least one polarization state, each notch having a FWHM no greater than 50, 35, or 20 nm.

17. The display of claim 1, wherein the spectrally variable reflectivity of the transflector changes as a function of incidence angle.

18. The display of claim 1, wherein the light emitted by the backlight is at least partially collimated.

19. The display of claim 18, wherein the light emitted by the backlight has a full angular width at half-maximum intensity no greater than 40° or 20° in at least one dimension.

20. The display of claim 1, wherein the backlight emits light of different colors in a temporal sequence.

21. The display of claim 1, wherein the backlight emits light of different colors in a spatial array.
